(19) United States
(12) Patent Application Publication
(10) Pub. No.: US 2019/0317656 A1
(43) Pub. Date: Oct. 17, 2019

(54) DRIVE LINE ALLOCATION

(71) Applicant: Tactual Labs Co., New York, NY (US)

(72) Inventor: Darren Leigh, Round Hill, VA (US)

(73) Assignee: Tactual Labs Co., New York, NY (US)

(21) Appl. No.: 16/383,954

(22) Filed: Apr. 15, 2019

Related U.S. Application Data
(60) Provisional application No. 62/703,122, filed on Jul. 25, 2018.
(60) Provisional application No. 62/657,244, filed on Apr. 13, 2018.

(51) Int. Cl. G06F 3/041; G06F 3/044

(52) U.S. Cl. CPC G06F 3/04166; G06F 3/04162; G06F 2203/04104; G06F 3/0446; G06F 2203/04108; G06F 3/0441

(57) ABSTRACT

Row conductors have enhanced sensitivity by having more than one transmitter connected to each of the row conductors. Each of the transmitters can transmit a different signal on more than one of the row conductors. Row groups can be formed by having one of the signals transmitted on a plurality of row conductors, while other signals are also transmitted on the row conductors. This can increase the sensitivity area for a sensor device and further noise present on the sensor device.

This application claims the benefit of U.S. Provisional Application Ser. No. 62/657,244, filed Apr. 13, 2018; and also claims the benefit of U.S. Provisional Application Ser. No. 62/703,122, filed Jul. 25, 2018, the entire disclosure of each of which is hereby incorporated herein by reference. This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The disclosed systems relate in general to the field of user input, and in particular to devices sensitive to touch, including, hover and pressure.

### BRIEF DESCRIPTION OF THE DRAWINGS

The foregoing and other objects, features, and advantages of the disclosure will be apparent from the following more particular description of embodiments as illustrated in the accompanying drawings in which reference characters refer to the same parts throughout the various views. The drawings are not necessarily to scale, emphasis instead being placed upon illustrating principles of the disclosed embodiments.

FIG. 1 is a high level block diagram illustrating an embodiment of a low-latency touch sensor device.

FIG. 2 is a diagram illustrating rows arranged in a cascading manner.

FIG. 3 is another diagram illustrating rows arranged in a cascading manner and further comprising an additional unique orthogonal signal transmitted on the row.

FIG. 4 is a diagram showing rows driven in a rolling fashion.

FIG. 5 is a diagram showing rows driven in a rolling fashion

FIG. 6 is a diagram showing rows driven in a rolling fashion.

FIG. 7 is a diagram showing multiple transmit antennas.

### DETAILED DESCRIPTION

In various embodiments, the present disclosure is directed to systems and devices (e.g., objects, panels or keyboards) sensitive to hover, contact and pressure and their applications in real-world, artificial reality, virtual reality and augmented reality settings. It will be understood by one of ordinary skill in the art that the disclosures herein apply generally to all types of systems using fast multi-touch to detect hover, contact and pressure.

Throughout this disclosure, the terms “touch”, “touches”, “touch event”, “contact”, “contacts”, “hover”, or “hovers” or other descriptors may be used to describe events or periods of time in which a key, user's finger, a stylus, an object, or a body part is detected by a sensor. In some sensors, detections occur only when the user is in physical contact with a sensor, or a device in which it is embodied. In some embodiments, and as generally denoted by the word “contact”, these detections occur as a result of physical contact with a sensor, or a device in which it is embodied. In other embodiments, and as sometimes generally referred to by the term “hover”, the sensor may be tuned to allow for the detection of “touches” that are hovering at a distance above the touch surface or otherwise separated from the sensor device and causes a recognizable change, despite the fact that the conductive or capacitive object, e.g., a finger, is not in actual physical contact with the surface. Therefore, the use of language within this description that implies reliance upon sensed physical contact should not be taken to mean that the techniques described apply only to those embodiments; indeed, nearly all, if not all, of what is described herein would apply equally to “contact” and “hover”, each of which is a “touch”. Generally, as used herein, the word “hover” refers to non-contact touch events or touch, and as used herein the term “hover” is one type of “touch” in the sense that “touch” is intended herein. Thus, as used herein, the phrase “touch event” and the word “touch” when used as a noun include a near touch and a near touch event, or any other gesture that can be identified using a sensor. “Pressure” refers to the force per unit area exerted by a user contact (e.g., presses by their fingers or hand) against the surface of an object. The amount of “pressure” is similarly a measure of “contact”, i.e., “touch”. “Touch” refers to the states of “hover”, “contact”, “pressure”, or “grip”, whereas a lack of “touch” is generally identified by signals being below a threshold for accurate measurement by the sensor. In accordance with an embodiment, touch events may be detected, processed, and supplied to downstream computational processes with very low latency, e.g., on the order of ten milliseconds or less, or on the order of less than one millisecond.

As used herein, and especially within the claims, ordinal terms such as first and second are not intended, in and of themselves, to imply sequence, time or uniqueness, but rather, are used to distinguish one claimed construct from another. In some uses where the context dictates, these terms may imply that the first and second are unique. For example, where an event occurs at a first time, and another event occurs at a second time, there is no intended implication that the first time occurs before the second time, after the second time or simultaneously with the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristic. Thus, for example, a first and a second frequency, absent further limitation, could be the same frequency, e.g., the first frequency being 10 Mhz and the second frequency being 10 Mhz; or could be different frequencies, e.g., the first frequency being 10 Mhz and the second frequency being 11 Mhz. Context may dictate otherwise, for example, where a first and a second frequency are further limited to being frequency-orthogonal to each other, in which case, they could not be the same frequency.

The presently disclosed systems and methods provide for designing and manufacturing sensors that employ a multiplexing scheme based on orthogonal signaling such as but not limited to frequency-division multiplexing (FDM), code-division multiplexing (CDM), or hybrid modulation techniques that can combine multiple schemes such as FDM and CDM methods. References to frequency herein could also refer to other orthogonal signal bases. As such, this application incorporates by reference Applicants' prior U.S. Pat. No. 9,019,224, entitled “Low-Latency Touch Sensitive Device” and U.S. Pat. No. 9,158,411 entitled “Fast Multi-Touch Post Processing.” These applications contemplate FDM, CDM, or FDM/CDM hybrid touch sensors which may be used in connection with the presently disclosed sensors. These applications contemplate FDM, CDM, or hybrid sensors which employ principles which may be used in connection with the presently disclosed sensors. In such sensors, touches are sensed when a signal from a row is coupled (increased) or decoupled (decreased) to a column and the result received on that column.

This application also employs principles used in fast multi-touch sensors and other interfaces disclosed in the following: U.S. Pat. Nos. 9,933,880; 9,019,224; 9,811,214; 9,804,721; 9,710,113; and 9,158,411. Familiarity with the disclosure, concepts and nomenclature within these patents is presumed. The entire disclosures of those patents and the applications incorporated therein by reference are incorporated herein by reference. This application also employs principles used in fast multi-touch sensors and other interfaces disclosed in the following: U.S. patent application Ser. Nos. 15/162,240; 15/690,234; 15/195,675; 15/200,642; 15/821,677; 15/904,953; 15/905,465; 15/943,221; 62/540,458, 62/575,005, 62/621,117, 62/619,656 and PCT publication PCT/US2017/050547, familiarity with the disclosures, concepts and nomenclature therein is presumed. The entire disclosure of those applications and the applications incorporated therein by reference are incorporated herein by reference.

In an embodiment, a fast multi-touch sensor utilizes a projected capacitive method that has been enhanced for high update rate and low latency measurements of touch events. The technique can use parallel hardware and higher frequency waveforms to gain the above advantages. Also disclosed are methods to make sensitive and robust measurements. These methods may be used on transparent display surfaces and may permit economical manufacturing of products which employ the technique. In this regard, a “capacitive object” as used herein could be a finger, another part of the human body, keyboard, a stylus, or any object to which the sensor is sensitive. The sensors and methods disclosed herein need not rely on capacitance. With respect to, e.g., an optical sensor, such embodiments utilize photon tunneling and leaking to sense a touch event, and a “capacitive object” as used herein includes any object, such as a stylus or finger, that that is compatible with such sensing. Similarly, “touch locations” and “touch sensitive device” as used herein do not require actual touching contact between a capacitive object and the disclosed sensor.

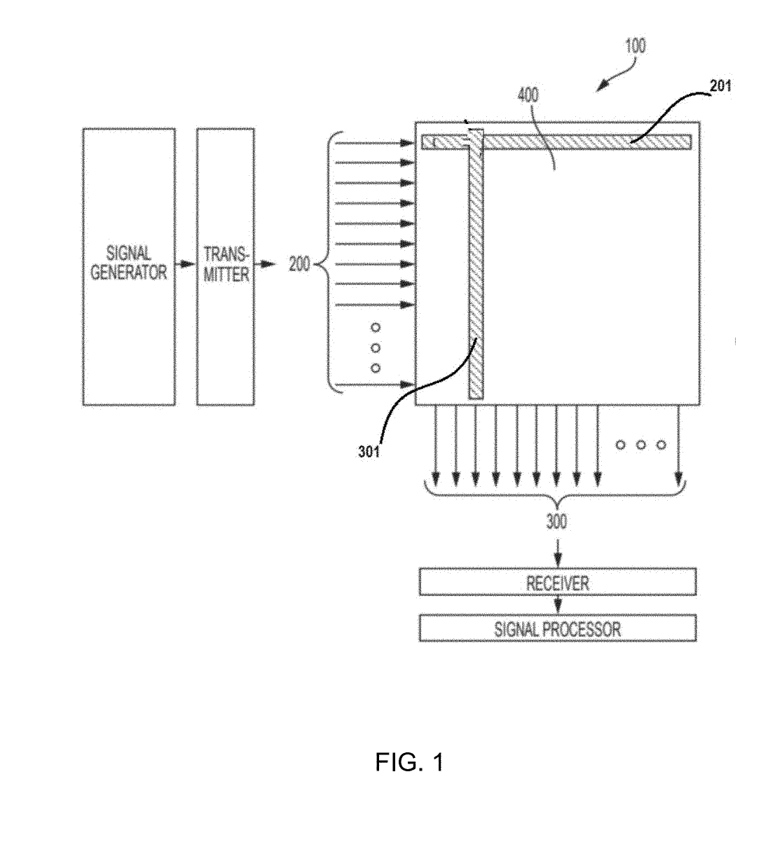

FIG. 1 illustrates certain principles of a fast multi-touch sensor 100 in accordance with an embodiment. At 200, a different signal is transmitted into each of the row conductors 201 of the touch surface 400. The signals are designed to be “orthogonal”, i.e., separable and distinguishable from each other. At 300, a receiver is attached to each column conductor 301. The row conductors 201 and the column conductors 301 are conductors/antennas that are able to transmit and/or receive signals. The receiver is designed to receive any of the transmitted signals, or an arbitrary combination of them, with or without other signals and/or noise, and to individually determine a measure, e.g., a quantity for each of the orthogonal transmitted signals present on that column conductor 301. The touch surface 400 of the sensor comprises a series of row conductors 201 and column conductors 301 (not all shown), along which the orthogonal signals can propagate. In an embodiment, the row conductors 201 and column conductors 301 are arranged such that a touch event will cause a change in coupling between at least one of the row conductors and at least one of the column conductors. In an embodiment, a touch event will cause a change in the amount (e.g., magnitude) of a signal transmitted on a row conductor that is detected in the column conductor. In an embodiment, a touch event will cause a change in the phase of a signal transmitted on a row conductor that is detected on a column conductor. Because the touch sensor ultimately detects touch due to a change in the coupling, it is not of specific importance, except for reasons that may otherwise be apparent to a particular embodiment, the type of change that is caused to the touch-related coupling by a touch. As discussed above, the touch, or touch event does not require a physical touching, but rather an event that affects the coupled signal. In an embodiment the touch or touch event does not require a physical touching, but rather an event that affects the coupled signal in a repeatable or predictable manner.

With continued reference to FIG. 1, in an embodiment, generally, the result of a touch event in the proximity of both a row conductor 201 and column conductor 301 causes a change in the signal that is transmitted on a row conductor as it is detected on a column conductor. In an embodiment, the change in coupling may be detected by comparing successive measurements on the column conductor. In an embodiment, the change in coupling may be detected by comparing the characteristics of the signal transmitted on the row conductor to a measurement made on the column conductor. In an embodiment, a change in coupling may be measured by both by comparing successive measurements on the column conductor and by comparing known characteristics of the signal transmitted on the row conductor to a measurement made on the column conductor. More generally, touch events cause, and thus correspond to, measurements of the signals on the column conductors 301. Because the signals on the row conductors 201 are orthogonal, multiple row signals can be coupled to a column conductor 301 and distinguished by the receiver. Likewise, the signals on each row conductor 201 can be coupled to multiple column conductors 301. For each column conductor 301 coupled to a given row conductor 201 (and regardless of how touch affects the coupling between the row conductor and column conductor), the signals measured on the column conductor 301 contain information that will indicate which row conductors 201 are being touched simultaneously with that column conductor 301. The magnitude or phase shift of each signal received is generally related to the amount of coupling between the column conductor 301 and the row conductor 201 carrying the corresponding signal, and thus, may indicate a distance of the touching object to the surface, an area of the surface covered by the touch and/or the pressure of the touch.

In various implementations of a touch device, physical contact with the row conductors 201 and/or column conductors 301 is unlikely or impossible as there may be a protective barrier between the row conductors 201 and/or column conductors 301 and the finger or other object of touch. Moreover, generally, the row conductors 201 and column conductors 301 themselves are not in physical contact with each other, but rather, placed in a proximity that allows signal to be coupled there-between, and that coupling changes with touch. Generally, the row-column conductor coupling results not from actual contact between them, nor by actual contact from the finger or other object of touch, but rather, by the effect of bringing the finger (or other object) into proximity—which proximity results in a change of coupling, which effect is referred to herein as touch.

In an embodiment, the orientation of the row conductors and column conductors may vary as a consequence of a physical process, and the change in the orientation (e.g., movement) of the row conductors and/or column conductors with respect to one-another may cause a change in coupling. In an embodiment, the orientation of a row conductor and a column conductor may vary as a consequence of a physical process, and the range of orientation between the row conductor and column conductor includes ohmic contact, thus in some orientations within a range a row conductor and column conductor may be in physical contact, while in other orientations within the range, the row conductor and column conductor are not in physical contact and may have their coupling varied. In an embodiment, when a row conductor and column conductor are not in physical contact their coupling may be varied as a consequence of moving closer together or further apart. In an embodiment, when a row conductor and column conductor are not in physical contact their coupling may be varied as a consequence of grounding. In an embodiment, when a row conductor and column conductor are not in physical contact their coupling may be varied as a consequence of materials translated within the coupled field. In an embodiment, when a row conductor and column conductor are not in physical contact their coupling may be varied as a consequence of a changing shape of the row conductor or column conductor, or an antenna associated with the row conductor or column conductor.

The nature of the row conductors 201 and column conductors 301 is arbitrary and the particular orientation is variable. Indeed, the terms row conductor 201 and column conductor 301 are not intended to refer to a square grid, but rather to a set of conductors upon which signal is transmitted (rows) and a set of conductors onto which signal may be coupled (columns). (The notion that signals are transmitted on row conductors 201 and received on column conductors 301 itself is arbitrary, and signals could as easily be transmitted on conductors arbitrarily designated column conductors and received on conductors arbitrarily named row conductors, or both could arbitrarily be named something else.) Further, it is not necessary that row conductors and column conductors be in a grid. Other shapes are possible as long as a touch event will affect a row-column coupling. For example, the “rows” could be in concentric circles and the “columns” could be spokes radiating out from the center. And neither the “rows” nor the “columns” need to follow any geometric or spatial pattern, thus, for example, the keys on a keyboard could be arbitrarily connected to form row conductors and column conductors (related or unrelated to their relative positions.) Moreover, an antenna may be used as a row conductor, having a more defined shape than a simple conductor wire such as for example a row made from ITO). For example an antenna may be round or rectangular, or have substantially any shape, or a shape that changes. An antenna used as a row conductor may be oriented in proximity to one or more conductors, or one or more other antennas that act as columns. In other words, in an embodiment, an antenna may be used for signal transmission and oriented in proximity to one or more conductors, or one or more other antennas that are used to receive signals. A touch will change the coupling between the antenna used for signal transmission and the signal used to receive signals.

It is not necessary for there to be only two types signal propagation channels: instead of row conductors and column conductors, in an embodiment, channels “A”, “B” and “C” may be provided, where signals transmitted on “A” could be received on “B” and “C”, or, in an embodiment, signals transmitted on “A” and “B” could be received on “C”. It is also possible that the signal propagation channels can alternate function, sometimes supporting transmitters and sometimes supporting receivers. It is also contemplated that the signal propagation channels can simultaneously support transmitters and receivers—provided that the signals transmitted are orthogonal, and thus separable, from the signals received. Three or more types of antenna or conductors may be used rather than just “rows” and “columns.” Many alternative embodiments are possible and will be apparent to a person of skill in the art after considering this disclosure.

It is likewise not necessary for there to be only one signal transmitted on each transmitting media. In an embodiment, multiple orthogonal signals are transmitted on each row. In an embodiment, multiple orthogonal signals are transmitted on each transmit antenna.

Returning briefly to FIG. 1, as noted above, in an embodiment the touch surface 400 comprises a series of row conductors 201 and column conductors 301, along which signals can propagate. As discussed above, the row conductors 201 and column conductors 301 are oriented so that, when they are not being touched the signals are coupled differently than when they are being touched. The change in signal coupled between them may be generally proportional or inversely proportional (although not necessarily linearly proportional) to the touch such that touch is measured as a gradation, permitting distinction between more touch (i.e., closer or firmer) and less touch (i.e., farther or softer)—and even no touch.

At 300, a receiver is attached to each column conductor 301. The receiver is designed to receive the signals present on the column conductors 301, including any of the orthogonal signals, or an arbitrary combination of the orthogonal signals, and any noise or other signals present. Generally, the receiver is designed to receive a frame of signals present on the column conductors 301, and to identify the columns providing signal. A frame of signals is received during an integration period or sampling period. In an embodiment, the receiver (or a signal processor associated with the receiver data) may determine a measure associated with the quantity of each of the orthogonal transmitted signals present on that column conductor 301 during the time the frame of signals was captured. In this manner, in addition to identifying the row conductors 201 in touch with each column conductor 301, the receiver can provide additional (e.g., qualitative) information concerning the touch. In general, touch events may correspond (or inversely correspond) to the received signals on the column conductors 301. For each column conductor 301, the different signals received thereon indicate which of the corresponding row conductors 201 is being touched simultaneously with that column conductor 301. In an embodiment, the amount of coupling between the corresponding row conductor 201 and column conductor 301 may indicate e.g., the area of the surface covered by the touch, the pressure of the touch, etc. In an embodiment, a change in coupling over time between the corresponding row conductor 201 and column conductor 301 indicates a change in touch at the intersection of the two.

In an embodiment, a mixed signal integrated circuit comprises signal generator, transmitter, receiver and signal processor. In an embodiment, the mixed signal integrated circuit is adapted to generate one or more signals and send the signals to transmit antennas. In an embodiment, the mixed signal integrated circuit is adapted to generate a plurality of frequency-orthogonal signals and send the plurality of frequency-orthogonal signals to the transmit antenna. In an embodiment, the mixed signal integrated circuit is adapted to generate a plurality of frequency-orthogonal signals and send one or more of the plurality of frequency-orthogonal signals to each of a plurality of rows. In an embodiment, the frequency-orthogonal signals are in the range from DC up to about 2.5 GHz. In an embodiment, the frequency-orthogonal signals are in the range from DC up to about 1.6 MHz. In an embodiment, the frequency-orthogonal signals are in the range from 50 KHz to 200 KHz. The frequency spacing between the frequency-orthogonal signals should be greater than or equal to the reciprocal of an integration period (i.e., the sampling period).

In an embodiment, the signal processor of a mixed signal integrated circuit (or a downstream component or software) is adapted to determine at least one value representing each frequency orthogonal signal transmitted to a row conductor. In an embodiment, the signal processor of the mixed signal integrated circuit (or a downstream component or software) performs a Fourier transform to received signals. In an embodiment, the mixed signal integrated circuit is adapted to digitize received signals. In an embodiment, the mixed signal integrated circuit (or a downstream component or software) is adapted to digitize received signals and perform a discrete Fourier transform (DFT) on the digitized information. In an embodiment, the mixed signal integrated circuit (or a downstream component or software) is adapted to digitize received signals and perform a Fast Fourier transform (FFT) on the digitized information—an FFT being one type of discrete Fourier transform.

It will be apparent to a person of skill in the art in view of this disclosure that a DFT, in essence, treats the sequence of digital samples (e.g., window) taken during a sampling period (e.g., integration period) as though it repeats. As a consequence, signals that are not center frequencies (i.e., not integer multiples of the reciprocal of the integration period (which reciprocal defines the minimum frequency spacing)), may have relatively nominal, but unintended consequence of contributing small values into other DFT bins. Thus, it will also be apparent to a person of skill in the art in view of this disclosure that the term orthogonal as used herein is not “violated” by such small contributions. In other words, as we use the term frequency orthogonal herein, two signals are considered frequency orthogonal if substantially all of the contribution of one signal to the DFT bins is made to different DFT bins than substantially all of the contribution of the other signal.

In an embodiment, received signals are sampled at at least 1 MHz. In an embodiment, received signals are sampled at at least 2 MHz. In an embodiment, received signals are sampled at 4 Mhz. In an embodiment, received signals are sampled at 4.096 Mhz. In an embodiment, received signals are sampled at more than 4 MHz.

To achieve kHz sampling, for example, 4096 samples may be taken at 4.096 MHz. In such an embodiment, the integration period is 1 millisecond, which per the constraint that the frequency spacing should be greater than or equal to the reciprocal of the integration period provides a minimum frequency spacing of 1 KHz. (It will be apparent to one of skill in the art in view of this disclosure that taking 4096 samples at e.g., 4 MHz would yield an integration period slightly longer than a millisecond, and not achieving kHz sampling, and a minimum frequency spacing of 976.5625 Hz.) In an embodiment, the frequency spacing is equal to the reciprocal of the integration period. In such an embodiment, the maximum frequency of a frequency-orthogonal signal range should be less than 2 MHz. In such an embodiment, the practical maximum frequency of a frequency-orthogonal signal range should be less than about 40% of the sampling rate, or about 1.6 MHz. In an embodiment, a DFT (which could be an FFT) is used to transform the digitized received signals into bins of information, each reflecting the frequency of a frequency-orthogonal signal transmitted which may have been transmitted by the transmit antenna 130. In an embodiment 2048 bins correspond to frequencies from 1 KHz to about 2 MHz. It will be apparent to a person of skill in the art in view of this disclosure that these examples are simply that, exemplary. Depending on the needs of a system, and subject to the constraints described above, the sample rate may be increased or decrease, the integration period may be adjusted, the frequency range may be adjusted, etc.

In an embodiment, a DFT (which can be an FFT) output comprises a bin for each frequency-orthogonal signal that is transmitted. In an embodiment, each DFT (which can be an FFT) bin comprises an in-phase (I) and quadrature (Q) component. In an embodiment, the sum of the squares of the I and Q components is used as measure corresponding to signal strength for that bin. In an embodiment, the square root of the sum of the squares of the I and Q components is used as measure corresponding to signal strength for that bin. It will be apparent to a person of skill in the art in view of this disclosure that a measure corresponding to the signal strength for a bin could be used as a measure related to touch. In other words, the measure corresponding to signal strength in a given bin would change as a result of a touch event.

The row conductor 201 and column conductor 301 setup shown in FIG. 1, provides the framework for the discussion related to the arrangements discussed below. Generally, in the discussion below, references to drivelines are generally referring to the row conductors upon which signals are being transmitted. However, it should be understood that the driveline may be a column conductor (or any other geometry, orientation, etc.) upon which a signal may be transmitted (i.e. the signal driven). References to row conductors and column conductors are for ease of discussion and variations thereof should be understood by those of skill in the art in view of the present disclosure.

Capacitive touch sensor design often involves a tradeoff between sensitivity and spatial resolution. The pitch of the row conductors and column conductors (i.e. the distance between the row conductors and column conductors) governs their widths and, therefore, how much area those row conductors and column conductors can expose to the touch object. Conductors, such as indium-tin oxide (ITO), also cause trade offs because their conductivity can attenuate the signals that propagate throughout the sensor.

The conductivity of the row conductors and column conductors of a capacitive touch sensor preferably minimize the attenuation of the signals propagating through them. Furthermore, the row conductors and column conductors should present a sufficient area to potential touching objects so as to have reasonable sensitivity. The row/column pitch is preferably such that a narrow touching object (such as a stylus) can be resolved with the necessary spatial resolution.

Some conditions can be satisfied by having wider row conductors and column conductors, and thus a coarser row/column pitch. Other conditions can be satisfied by having a finer row/column pitch by having narrower row conductors and column conductors. Preferably an arrangement can be made by which both sufficient conductivity and fine spatial resolution is achieved in a single touch sensor.

A group of narrower row conductors (or column conductors) may be used in parallel, thus decreasing the resistance of the larger “group” row. For example, a group of n narrow row conductors will have

$$\frac{1}{n}$$

the resistance or each or the original row conductors. The larger group row will also have n times the surface area over which it can interact with touching or hovering objects.

Paralleling a group of row conductors is similar to having wider row conductors with the resulting coarser row/column pitch. In order to gain the advantages of a fine row/column pitch along with the parallelism, the row conductors may be multiplexed. The multiplexing can be done with respect to time or with through the use of the signals. The multiplexing may also be done intelligently so that the system can focus on only certain areas of the sensor at certain times. In other words, when a touch event is detected, the manner in which the area in which the touch event is occurring may be multiplexed in a specific manner (for example either via time or through signals) in order to take advantage of the particular scenario. In other words, if finer resolution is required the appropriate multiplexing scheme can be applied.

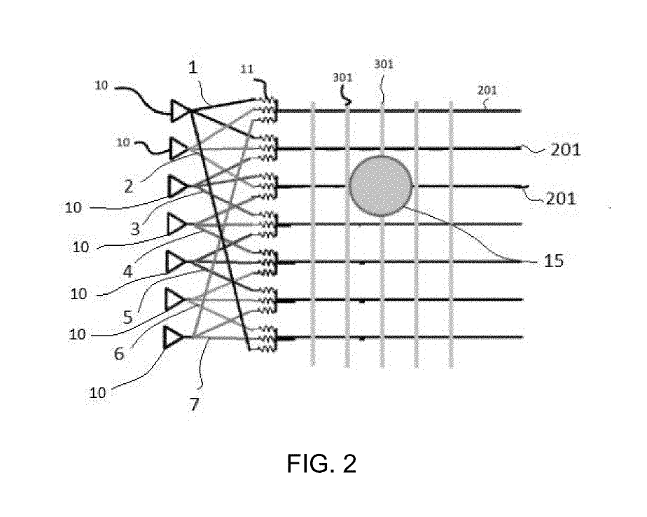

Referring now to FIG. 2, an embodiment is shown of a sensor comprising row conductors 201 and column conductors 301. The row conductors 201 and the column conductors 301 cross each other. The pitch between each of the row conductors 201 is substantially the same. As discussed previously, reference to rows and columns is for convenience of discussion and other arrangements are possible, as described above. Shown in FIG. 2 is a plurality of row conductors 201 and a plurality of column conductors 301. The row conductors 201 are ultimately operably connected to a signal generator or signal generators that are able to generate signals that are transmitted on each of the row conductors 201. The column conductors 301 are ultimately operably connected to receivers.

The arrangement shown in FIG. 2 is a “cascaded” arrangement of row conductors 201. The cascaded arrangement enhances sensitivity of the sensor. In a cascaded arrangement, each row conductor 201 has connected thereto a number transmitters 10 and resistors 11. The number of resistors 11 correspond to the number of transmitters 10 that are connected to each row conductor 201. The number of transmitters 10 and the number of resistors 11 can vary depending upon the needs of the sensor and the overall dimensions and geometry of the sensor.

In the arrangement shown in FIG. 2 there are three transmitters 10 connected to each of the row conductors 201 with each of the three transmitters 10 connected to one of each of the three resistors 11 connected to the row conductor 201. In an embodiment there are two transmitters 10 connected to each row conductor 201. In an embodiment there are four transmitters 10 connected to each row conductor 201. In an embodiment there are more than four transmitters 10 connected to each row conductor 201. In an embodiment there are a variable number of transmitters 10 connected to each row conductor 201, for example one transmitter 10 connected to a first row conductor 201, two transmitters 10 connected to the second row conductor 201, three transmitters connected to the third row conductor 201, etc. In an embodiment the number of transmitters 10 can alternate between one and two connected to a row conductor 201. In an embodiment each of the row conductors 201 and transmitters 10 are connected in parallel.

Still referring to FIG. 2, each row conductor 201 has three transmitters 10 connected thereto. For example, the top row conductor 201 shown in FIG. 2 has a transmitter 10 that transmits signal 1 to it, a transmitter 10 that transmits signal 2 to it and a transmitter 10 that transmits signal 7 to it. Similarly, the third row conductor 201 from the top as a transmitter 10 that transmits signal 3 to it, transmitter 10 that transmits signal 4 to it and a transmitter 10 that transmits signal 2 to it Similarly, the fifth row conductor 201 as a transmitter 10 that transmits signal 4 to it, a transmitter 10 that transmits signal 5 to it and a transmitter 10 that transmits signal 6 to it. In an embodiment, each transmitter 10 transmits a unique frequency orthogonal signal. In an embodiment, each transmitter 10 transmits their signal during each frame. In an embodiment, every other transmitter 10 transmits during every other frame. In an embodiment, each of a more than one row conductor 201 may have the same signal transmitted thereon. In an embodiment, three row conductors 201 may have the same signal transmitted thereon. When the signals are transmitted on their respective row conductors 201, an amount of that signal can be measured at each column 301 that is coupled to that row conductor 201. The touch event will alter the amount of signal that corresponds to that row conductor 201 at each of the column conductors 301.

So for example, with respect to the touch event 15 in FIG. 2, at the center of the circle, signals from the second, third and fourth transmitters 10 from the top transmitting signal 2, signal 3 and signal 4 respectively are measured at the column conductors 301. Additionally, those signals from other transmitters 10 connected to row conductors 201 located nearby the touch event 15 will also be received at column conductors 301. The additional measured signals provide additional information about the touch event 15 and increases the sensitivity of the sensor.

When the same signal is placed over a row made of ITO a certain amount of resistance is met. As discussed above, if the same signal is placed across three row conductors 201 in parallel, less resistance is met by the transmitted signal. Therefore a tradeoff can be either more row conductors which may cause more expense and improve optical quality or fewer row conductors resulting in lower resolution. A way to avoid having to make the tradeoff is by charging the rows sequentially, thereby maintaining the reduced resistance benefit and keeping the improved resolution. However, since the row conductors are charged sequentially, more frames may be needed and the frame rate may decrease.

The cascaded row conductors 201 and column conductors 301 perform multiplexing in the signals to gain the advantages of both paralleling and fine-pitch rows. As shown in FIG. 2, each row signal is transmitted to a group of row conductors 201. In an embodiment, the row conductors 201 comprising a group are adjacent to each other. In an embodiment, the row conductors 201 comprising a group are not adjacent to each other. In an embodiment, the row conductors 201 comprising a group have some row conductors 201 that adjacent to each other and some row conductors 201 that are not adjacent to each other. A group may be defined by whether or not it contains a particular row conductor 201. For example, group 1 may be all row conductors 201 that contain signal 2. A touch event from an object that is approximately the size of group 1 will affect the transmission of all of the signals associated with group 1, plus some extra from the groups located on either side, which it would have done anyway without the cascading. A touch event from a narrower object will affect a smaller number of row conductor signals.

The signals transmitted on the row conductors 201 may either be transmitted into each individual row conductor 201 as combinations of more fundamental row signals (e.g. sinusoids that would have gone into individual row conductors for an OFD-based touch system), or they may be combined from the original transmitters 10. In an embodiment, each transmitter 10 is associated with a single row conductor 201 and sends that row conductor 201 the appropriate combination of signals. In an embodiment, that combination of signals is a combination of sinusoids. In an embodiment, that combination of signals is a combination of code-division modulated signals. In an embodiment, the transmitters generate only basic signals and these are combined externally and sent to the row conductors 201. In an embodiment, the signals are combined with resistors 11, which serve to couple to the signals from transmitter 10 to each row conductor 201 as well as to isolate the transmitters 10 from each other. In an embodiment, the signals are combined with analog summation circuitry.

The cascaded rows method is similar to convolution in that the signals are spread beyond the central row according to a “point spread function”. Therefore, deconvolution techniques can be useful in determining a more precise location for the touch event.

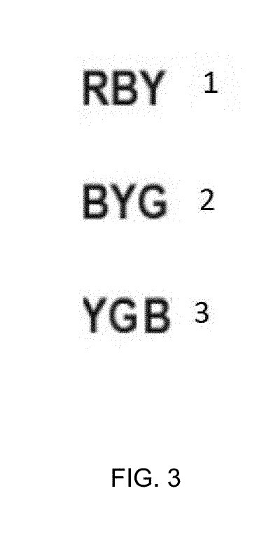

FIG. 3 shows an alternative embodiment that employs the cascade method and arrangement discussed above. In addition to each of the row conductors having a combination of signals that are also transmitted on different row conductors, each row conductor may have a separate unique signal transmitted only on that row conductor. So the row conductor with the combined RBY signals transmitted on it may also have the signal 1 transmitted thereon and the row conductor with the combined YGB signal transmitted on it may also have signal 3 transmitted. So there may be a grouping of signals, such as B grouping in FIG. 3, that are received by the column conductors, but additionally a unique signal that is directly associated with something else besides the grouping, for example a stylus. Additionally, the unique signal per the row conductors may additionally be used to discriminate touch events.

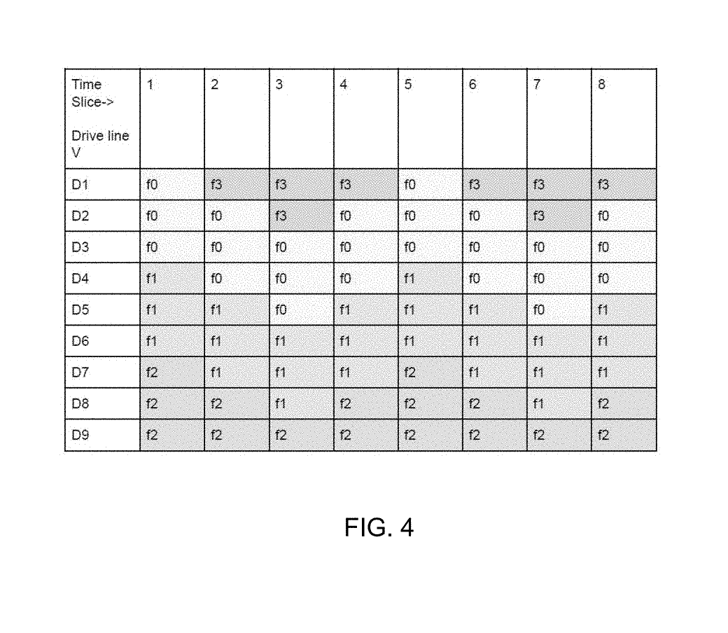

FIG. 4 illustrates an embodiment showing nine row conductors labeled D1-D9 with different frequencies transmitted over the row conductors during different time slices (i.e. frames). This type of method is a “rolling” method. Each row conductor has different transmitters (not shown) connected thereto. During each frame a different frequency is transmitted on a row conductor. For example in frame 1, f0 is transmitted on row conductors D1-D3, f1 is transmitted on row conductors D4-D6 and f2 is transmitted on row conductors D7-D9. In the next frame, frame 2, f3 is transmitted on row conductor D1, f0 is transmitted on row conductors D2-D4, f1 is transmitted on row conductors D5-D7 and f2 is transmitted on row conductors D8-D9. During each frame, that respective signals are detectable at the respective row conductors. This can provide a robust view of the signals being detected that can avoid certain interference issues.

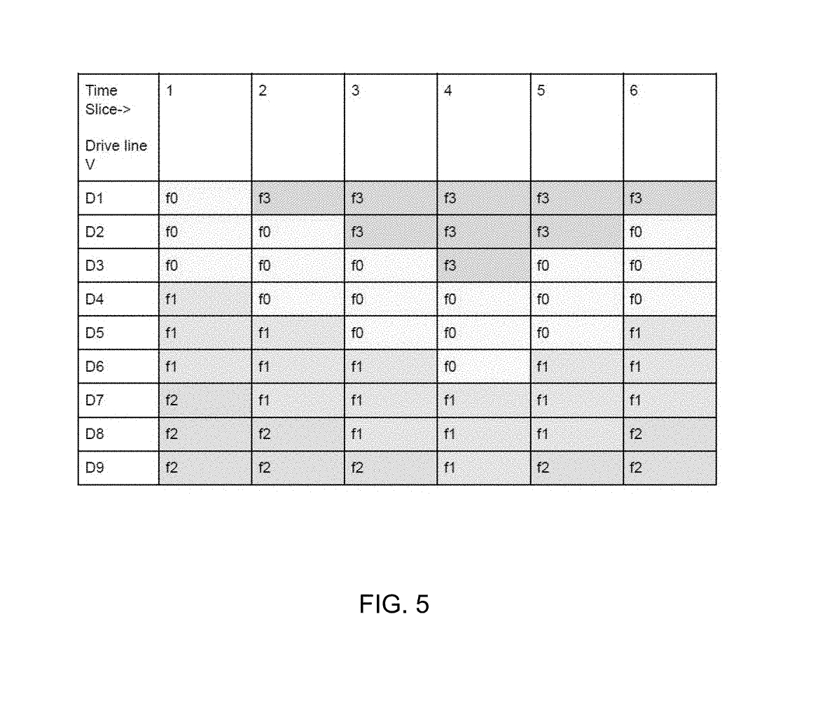

FIG. 5 illustrates another embodiment showing nine row conductors labeled D1-D9 with different frequencies transmitted over the row conductors during different time slices (i.e. frames). Each row conductor 201 has different transmitters 10 (not shown) connected thereto. During each frame a different frequency is transmitted on a row conductor 201. In frame 3, f3 is transmitted on row conductors D1-D2, f0 is transmitted on row conductors D3-D5, f1 is transmitted on row conductors D6-D8 and f2 is transmitted on row conductors D9. In the next frame, frame 4, f3 is transmitted on row conductors D1-D3, f0 is transmitted on row conductors D4-D6 and f1 is transmitted on row conductors D7-D9. During each frame, that respective signals are detectable at the respective row conductors.

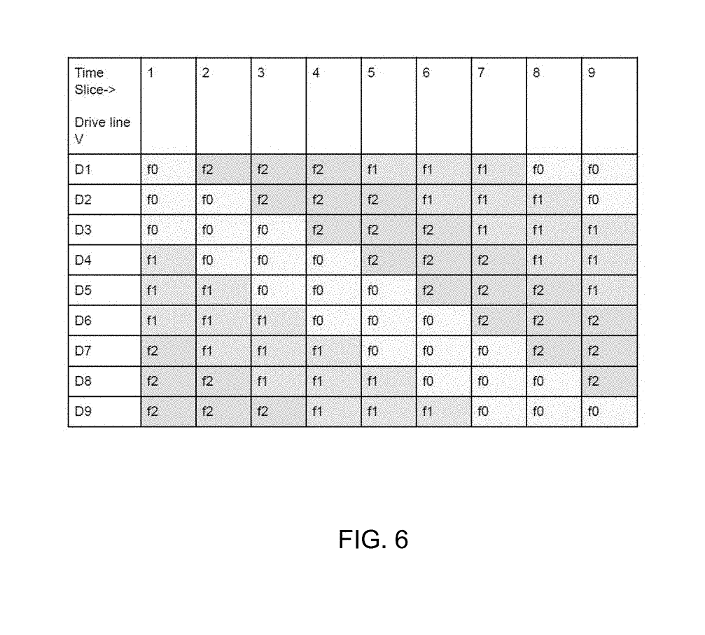

FIG. 6 illustrates another embodiment showing nine row conductors labeled D1-D9 with different frequencies transmitted over the row conductors during different time slices (i.e. frames). Each row conductor 201 has different transmitters 10 (not shown) connected thereto. During each frame a different frequency is transmitted on a row conductor 201. Here in frame 1, f0 is transmitted on row conductors D1-D3, f1 is transmitted on row conductors D4-D6, f2 is transmitted on row conductors D7-D9. In the next frame, frame 2, f2 is transmitted on row conductors D1, f0 is transmitted on row conductors D2-D4, f1 is transmitted on row conductors D5-D7 and f2 is transmitted on row conductors D8-D9. During each frame, that respective signals are detectable at the respective row conductors.

In an embodiment, the shifting of the row conductors and the shifting of the column conductors alternates, with each performing at least a group width number of shifts before the other has its turn. A “group width” is the number of row conductors (or column conductors) that has the same signal being transmitted on the row conductor. For example, group 1 shown in FIG. 2 has a group width of three. In an embodiment, the shifting of row conductors and the shifting of column conductors alternates, with each performing fewer than the group width of shifts before the other has its turn. In an embodiment, the row groups shift by one row conductor and then the column groups shift by one column conductor. In an embodiment, the row groups and column groups shift during each frame.

Different group shifting patterns may avoid problems such as artifacts that may occur at the edges of sensors. In an embodiment, the rolling method and the cascade method can be combined in order to create a robust, sensitive and varied response from the sensors. In an embodiment, the row conductors may use one method and the column conductors may use the other. In an embodiment, the row conductors and column conductors each use one of the methods, but alternate which one uses which method. Additional, row conductor and column conductor interpolation may be used to increase the spatial resolution of touch detection. In an embodiment, the interpolation can be combined with a deconvolution technique to optimize the spatial resolution and increase the precision of touch events. It should be understood that these methods may additionally be used with other arrangements of conductors instead of or in addition to row and column conductors. For example arrangements implementing the methods discussed above may be accomplished with arrays of row and column conductors. In an embodiment, arrangements implementing the methods discussed above may be accomplished with circular arrangements of conductors. Arrangements implementing the methods discussed above may be accomplished with geometric patterns of conductors.

In addition to scanning the entire sensor panel using the rolling method or the cascade method to achieve higher resolution with parallel row conductors (or column conductors). These methods may be performed on portions of the screen, and only at certain times. For example, in an embodiment the touch system may work in a normal mode sensing finger touches, which require lower resolution. However, when a stylus is being used the system may switch to the cascade mode. In an embodiment, the system may switch to the rolling method. In an embodiment, the system switches between the rolling mode and the cascade mode. In an embodiment, the system switches from a normal operating mode, to a rolling mode and then to a cascade mode and variations therebetween. These modes may be switched to in order to increase the resolution only at times when the stylus is active, or when the stylus is touching the sensor, and only at locations near where the stylus is touching. In an embodiment, the touch system first detects the coarse position of the stylus, and then uses the rolling method or the cascade method to detect the fine position of the stylus.

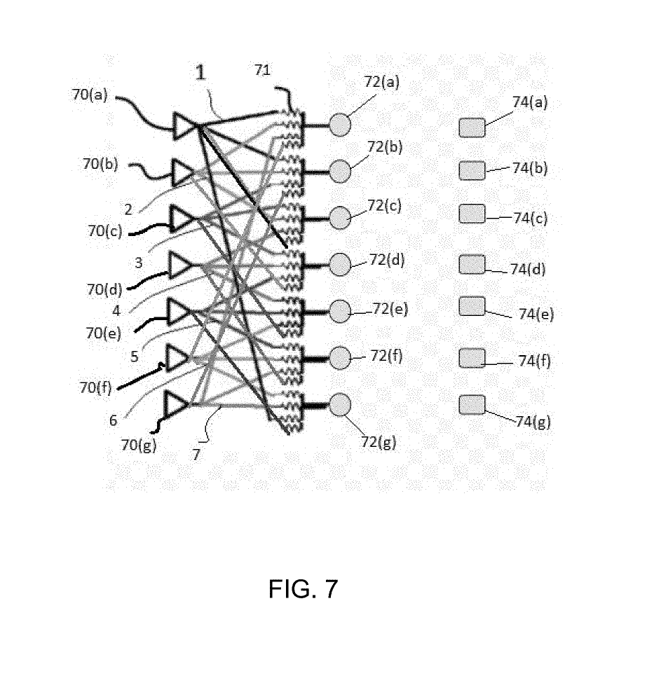

Referring now to FIG. 7, an embodiment is shown comprising a plurality of transmitters 70(a)-70(g) operably connected to resistors 71 and transmit antennas 72(a)-72(g). The transmitters 70(a)-70(g) are operably connected to a signal generator (not shown). An array of receive antennas 74(a)-74(g) are provided and adapted to receive signals transmitted from the transmit antennas 70(a)-70(g). The receive antennas 74(a)-74(g) are operably connected to a signal processor (not shown).

In the arrangement shown in FIG. 7 there are four transmitters connected to each of the transmit antennas with each of the four transmitters connected to one of each of the four resistors connected to the transmit antenna. For example, transmitter 70(a) is connected via resistors 71 to transmit antennas 72(a), 72(b), 72(c) and 70(g) and transmits signal 1. Transmitter 70(b) is connected via resistors 71 to transmit antennas 72(a), 72(b), 72(c) and 70(d) and transmits signal 2. Transmitter 70(c) is connected via resistors 71 to transmit antennas 72(b), 72(c), 72(d) and 70(e) and transmits signal 3. Transmitter 70(d) is connected via resistors 71 to transmit antennas 72(c), 72(d), 72(e) and 70(f) and transmits signal 4. Transmitter 70(e) is connected via resistors 71 to transmit antennas 72(d), 72(e), 72(f) and 70(g) and transmits signal 5. Transmitter 70(f) is connected via resistors 71 to transmit antennas 72(a), 72(e), 72(f) and 70(g) and transmits signal 6. Transmitter 70(g) is connected via resistors 71 to transmit antennas 72(a), 72(b), 72(f) and 70(g) and transmits signal 7.

In an embodiment, each of the transmitters generates a unique frequency orthogonal signal. In an embodiment, each of the unique frequency orthogonal signals are transmitted simultaneously from the transmitters to each of the transmit antennas to which they are connected. Signals received at the receive antennas are processed in order to determine interactions that occurred with the signals. Processed signals can be used to determine touch events and other interactions that can be discerned from the signals. For example, position and movement of an object can be determined from the interaction with the signals. Transmitting the same signal on more than one transmit antenna creates a signal space for that signal that is able to be analyzed differently on each of the receive antennas.

In an embodiment there are two transmitters connected to each transmit antenna. In an embodiment there are three transmitters connected to each transmit antenna. In an embodiment there are more than four transmitters connected to each transmit antenna. In an embodiment there are a variable number of transmitters connected to each transmit antenna, for example one transmitter connected to a first transmit antenna, two transmitters connected to a second transmit antenna, three transmitters connected to the third transmit antenna, etc. In an embodiment the number of transmitters can alternate between one and two connected to a transmit antenna.

In an embodiment, each transmitter transmits on its respective group of transmit antennas to which it is attached at different times. In an embodiment, each transmitter transmits a unique orthogonal signal. In an embodiment, each transmitter transmits a unique frequency orthogonal signal. In an embodiment, each transmitter transmits their signal during each frame. In an embodiment, every other transmitter transmits during every other frame. In an embodiment, each of a more than one transmit antennas may have the same signal transmitted thereon. In an embodiment, four transmit antenna may have the same signal transmitted thereon. When the signals are transmitted on their respective transmit antennas, an amount of that signal can be measured at each of the receive antennas that is coupled to that transmit antenna. A touch event or other interaction with the signal space will alter the amount of signal that corresponds to that transmit antenna at each of the receive antennas. Additional measured signals provide additional information about events and increases the sensitivity of the sensor.

An embodiment of the disclosure is a sensor device, comprising a plurality of first conductors; a plurality of second conductors positioned in proximity to the plurality of first conductors such that a touch event proximate to the sensor device causes a change in coupling between at least one of the plurality of first conductors and at least one of the plurality of second conductors; and a plurality of transmitters operably connected to each one of the plurality of first conductors, wherein each of the transmitters is adapted to transmit a unique orthogonal signal with respect to each other unique orthogonal transmitted by each one of the plurality of transmitters, wherein at least one of the plurality of transmitters is connected to at least two of the plurality of first conductors and the unique orthogonal signal is transmitted simultaneously on the at least two of the plurality of first conductors.

Another embodiment of the disclosure is a sensor device, comprising: a plurality of first conductors; a plurality of second conductors positioned in proximity to the plurality of first conductors such that a touch event proximate to the sensor device causes a change in coupling between at least one of the plurality of first conductors and at least one of the plurality of second conductors; and wherein each one of the plurality of first conductors is adapted to transmit more than one unique frequency orthogonal signal, wherein at least one of the unique frequency orthogonal signals is transmitted on a different one of the plurality of first conductors selected during each frame.

The several embodiments discussed above illustrate a variety of systems for detecting touch events, but are not intended to limit the scope of the claims. Other systems' methods to improve touch data will become apparent to persons of skill in the art in view of this disclosure, and are thus included within the scope of this disclosure.

While the invention has been particularly shown and described with reference to a preferred embodiment thereof, it will be understood by those skilled in the art that various changes in form and details may be made therein without departing from the spirit and scope of the invention.

1. A sensor device, comprising:
a plurality of first conductors;
a plurality of second conductors positioned in proximity to the plurality of first conductors such that a touch event proximate to the sensor device causes a change in coupling between at least one of the plurality of first conductors and at least one of the plurality of second conductors; and
a plurality of transmitters operably connected to each one of the plurality of first conductors, wherein each of the transmitters is adapted to transmit a unique orthogonal signal with respect to each other unique orthogonal transmitted by each one of the plurality of transmitters, wherein at least one of the plurality of transmitters is connected to at least two of the plurality of first conductors and the unique orthogonal signal is transmitted simultaneously on the at least two of the plurality of first conductors.

2. The sensor device of claim 1, wherein each of one of the plurality of first conductors is connected to at least three transmitters from the plurality of transmitters.

3. The sensor device of claim 1, wherein the at least one of the plurality of transmitters is connected to at least three of the plurality of first conductors.

4. The sensor device of claim 1, wherein each of the plurality of first conductors has at least three transmitters from the plurality of transmitters connected thereto and each of the at least three transmitters from the plurality of transmitters has a resistor connected thereto.

5. The sensor device of claim 1, wherein each one of the plurality of transmitters is operably connected to a resistor.

6. The sensor device of claim 1, wherein the unique orthogonal signal is a unique frequency orthogonal signal.

7. The sensor device of claim 6, wherein the same unique frequency orthogonal signal is transmitted simultaneously to each member of the row group.

8. The sensor device of claim 1, further wherein each one of the plurality of transmitters is adapted to transmit a different unique orthogonal signals on different ones of the first plurality of conductors during each frame.

9. The sensor device of claim 8, wherein a different unique orthogonal signal is transmitted on at least one of the plurality of first conductors during sequential frames.

10. The sensor device of claim 1, wherein the sensor device detects when a stylus is located proximate to the sensor device and switches a number of unique orthogonal signals transmitted on the plurality of first conductor upon detection of the stylus proximate to the sensor device.

11. A sensor device, comprising:
a plurality of first conductors;
a plurality of second conductors positioned in proximity to the plurality of first conductors such that a touch event proximate to the sensor device causes a change in coupling between at least one of the plurality of first conductors and at least one of the plurality of second conductors; and
wherein each one of the plurality of first conductors is adapted to transmit more than one unique frequency orthogonal signal, wherein at least one of the unique frequency orthogonal signals is transmitted on a different one of the plurality of first conductors selected during each frame.

12. The sensor device of claim 11, wherein at least one of the unique frequency orthogonal signals is transmitted on at least two of the plurality of first conductors simultaneously.

13. The sensor device of claim 11, wherein a different unique frequency orthogonal signal is transmitted on at least one of the plurality of first conductors during sequential frames.

14. The sensor device of claim 11, wherein the sensor device detects when a stylus is proximate to the sensor device and switches a number of unique frequency orthogonal signals transmitted on the plurality of first conductors upon detection of the stylus proximate to the sensor device.

15. The sensor device of claim 11, wherein each of the plurality of first conductors is adapted to transmit at least three unique frequency orthogonal signals.

16. The sensor device of claim 11, wherein at least one unique frequency orthogonal signal is adapted to be transmitted on at least three of the plurality of first conductors at the same time.

17. The sensor device of claim 11, wherein each of the plurality of first conductors has at least three transmitters connected thereto and each of the at least three transmitters has a resistor connected thereto.

18. The sensor device of claim 17, wherein each of at least three transmitters is operably connected to a resistor.

19. The sensor device of claim 11, further comprising a conductor group wherein the conductor group comprises at least two of the plurality of first conductors.

20. The sensor device of claim 19, wherein the same unique orthogonal frequency signal is transmitted simultaneously on the conductor group.
